(19) United States
(12) Patent Application Publication
(10) Pub. No.: US 2013/0315042 A1
(43) Pub. Date: Nov. 28, 2013

(54) Geo-normalization of Calendar Items

(71) Applicant: Charles Kindel, Bellevue, WA (US)

(72) Inventor: Charles Kindel, Bellevue, WA (US)

(73) Assignee: BIZLOGR, INC, Redmond, WA (US)

(21) Appl. No.: 13/480,103

(22) Filed: May 24, 2012

(51) Int. Cl. G04B 47/00

(52) U.S. Cl. 368/10

(57) ABSTRACT

Calendar items may be analyzed to determine the physical location of an event defined in a calendar item. When a resolvable location is not included in the calendar item, other information may be used to increase the probability and accuracy of the location. For example, meeting attendees, adjacent meetings, meeting metadata, or similar meetings may be used to augment or verify a location for a calendar item. In some cases, external data from social networks, Global Positioning System input, or other data may also be used. Some embodiments may operate in a two-step analysis, where the first step may identify a boundary, and a second step may search within that boundary for potential matching locations. The location of a calendar item may be used for various auditing purposes, such as verifying work, mileage, or receipt logs, or for generating reports indicating the physical location of a person, device, or event.

### BACKGROUND

Calendar systems maintain a user's appointments, meetings, and other dates. Many electronic calendar systems store appointments and remind the user when the appointment draws near. Some calendared events may include other users, such as meetings where the calendar system may send invites to the users and track their responses.

### SUMMARY

Calendar items may be analyzed to determine the physical location of an event defined in a calendar item. When a resolvable location is not included in the calendar item, other information may be used to increase the probability and accuracy of the location. For example, meeting attendees, adjacent meetings, meeting metadata, or similar meetings may be used to augment or verify a location for a calendar item. In some cases, external data from social networks, Global Positioning System input, or other data may also be used. Some embodiments may operate in a two-step analysis, where the first step may identify a boundary, and a second step may search within that boundary for potential matching locations. The location of a calendar item may be used for various auditing purposes, such as verifying work, mileage, or receipt logs, or for generating reports indicating the physical location of a person, device, or event.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system for determining the physical location of a calendar item.

FIG. 2 is a diagram illustration of an embodiment showing an example set of calendar items and a map illustrating the physical location of the items.

FIG. 3 is a flowchart illustration of an embodiment showing a method for automatically determining a physical location of a calendar item.

FIG. 4 is a flowchart illustration of an embodiment showing a method for soliciting user input to verify or change automatically determined locations of calendar items.

### DETAILED DESCRIPTION

Calendar items may be automatically analyzed to determine the physical location of an event. Various data, including other calendar items and other data sources may be used to estimate the physical location associated with a calendar item. Since calendar items have an associated date and time, a given calendar item may be matched to another item that has a date and time that is close. When the other item has a location that may be either explicitly or implicitly known, a physical distance between the two items may be estimated and therefore the calendar item location may be inferred.

In many embodiments, two or more different items may be used in conjunction with each other to refine or better estimate the location of a calendar item. Once a range of possible locations are known, the precise location may be determined using a second set of analysis which may examine a user's history as defined in a calendar.

The location of the calendar item may be an estimate in many cases. The estimate may be useful in some embodiments where a general location is sufficient. For example, a user may wish to look back over a period of time and know the general vicinity of their travels. This may be useful for monitoring an employee who is a technician working at various customer's locations.

In some embodiments, a more precise estimate may be desired. For example, a system may be used to determine the number of miles driven by a user for accounting purposes. The number of miles may be used to reimburse the user or for the user to deduct as an expense on their taxes.

In embodiments where a more precise location is desired, a user may be presented with a user interface through which a user may manually verify or change estimated locations for certain calendar items. In many embodiments, manual user input may be captured and saved for use in future analysis.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be for example, but not limited to, an electronic, magnetic, optical, electromagnetic, infrared, or semiconductor system, apparatus, device, or propagation medium. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and may be accessed by an instruction execution system. Note that the computer-usable or computer-readable medium can be paper or other suitable medium upon which the program is printed, as the program can be electronically captured via, for instance, optical scanning of the paper or other suitable medium, then compiled, interpreted, of otherwise processed in a suitable manner, if necessary, and then stored in a computer memory.

Communication media typically embodies computer-readable instructions, data structures, program modules or other data in a modulated data signal such as a carrier wave or other transport mechanism and includes any information delivery media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media.

When the subject matter is embodied in the general context of computer-executable instructions, the embodiment may comprise program modules, executed by one or more systems, computers, or other devices. Generally, program modules include routines, programs, objects, components, data structures, and the like, that perform particular tasks or implement particular abstract data types. Typically, the functionality of the program modules may be combined or distributed as desired in various embodiments.

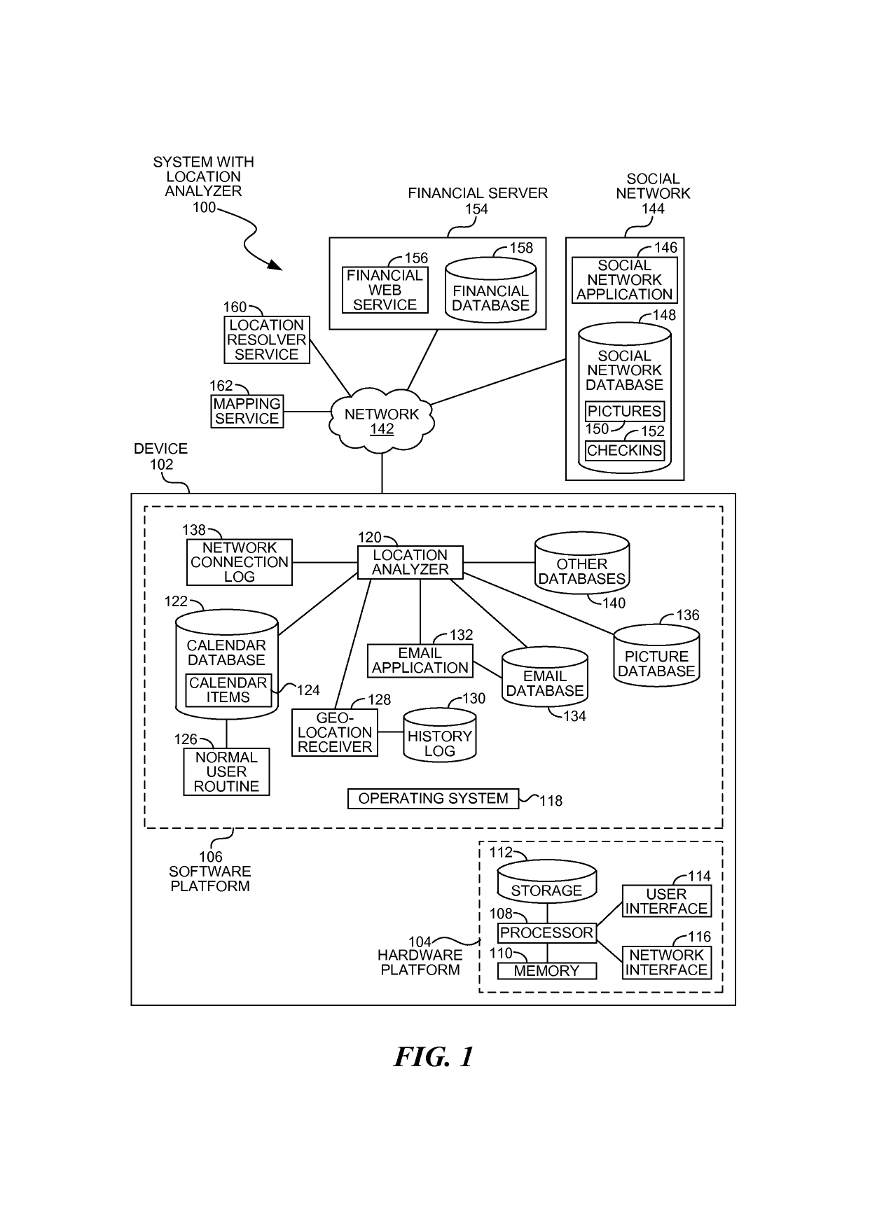

FIG. 1 is a diagram of an embodiment 100, showing a system for analyzing calendar items to determine a location for the items. Embodiment 100 is a simplified example of a network environment in which locations may be determined for calendar items using calendar data and other data sources.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Calendar systems are used by many people in many different manners. With the advent of smartphones, many people use some sort of calendaring function to manage their daily lives by setting reminders about events, meetings, or other functions.

Calendar items often have a parameter for location, but users may fail to enter the value or may enter a value that may be hard to properly identify. For example, a user may just put a shorthand notation for a coffee shop, restaurant, or other location where the user knows the notation but may be hard to automatically analyze using a computer.

Automatic analysis of a calendar item may be useful in several different scenarios. In one scenario, a set of calendar entries may be analyzed to determine where a person drove in their car. The mileage attributed to work related items may be a tax deductible expense, and an automatic analysis may identify the location of various calendar events and calculate the number of miles travelled. Such an embodiment may analyze historical or past calendar items.

In another scenario, a future calendar item may be analyzed to identify the specific location where a meeting or event may happen, so that the user may be alerted with enough time to travel to the meeting.

When a calendar item is not fully defined or not defined at all, other items that have a date, time, and location may be compared to the calendar item to determine an approximate location. For example, a user's credit card receipts may be compared to a calendar item meeting that may be listed as merely “coffee shop”. The credit card receipt from the user's credit card at a specific coffee shop at the same time as the meeting may indicate the precise location of the meeting.

Some embodiments may use a two-step approach to analyzing calendar items. The first step may create a boundary where a calendar item may be located. The boundary may be formed from events that happen before, after, and during a calendar item. From a given item that has a date, time, and location, a radius or travel boundary may be determined. By bracketing a calendar item using at least one other item, the scope of a search for a location may be limited.

The second step may be to search within the boundary to identify locations that have some relationship to the user and the calendar item. Based on the strength of the relationships, a probability may be assigned for each of the various location options. A ranked list of probable options may be created, and the most probable option may be automatically selected.

In the first step, any item that has a date, time, and location information that can be tied to the user may be a candidate for evaluation. In some instances, the location information may be express, such as a photograph with a date and time stamp as well as Global Positioning System coordinates. In other instances, the location may be implied, such as a checkin at a social networking site.

Many different items may be routinely collected that contain date, time, and an implied or express location. Examples may include financial records, such as credit card receipts where the credit card was physically presented to a card reader, automated toll collection devices, or any place that a transaction took place, such as checking out a book from a library or buying groceries and presenting an affinity card.

Some operations of a user's device may have date, time, and location metadata associated with it. For example, many cameras have GPS receivers that add location metadata to a picture along with date and time. In another example, a user's email may have date, time, and an Internet Protocol (IP) address from the sending location. The IP address may imply a physical location, which may be determined through a reverse lookup service.

After defining a probable boundary for a calendar item, a secondary search may be performed that selects possible locations within that boundary. The secondary search may attempt to find relationships between possible locations and the calendar item. In some cases, the user's history may be an indicator, such as when the user frequently visits a particular restaurant. In other cases, an attendee at a meeting may indicate clues to the location, such as when a meeting is at or in the vicinity of an attendee's office. The secondary search may attempt to further refine the location.

The device 102 is illustrated having hardware components 104 and software components 106. The device 102 as illustrated represents a conventional computing device, although other embodiments may have different configurations, architectures, or components.

In many embodiments, the device 102 may be a personal computer, smartphone, or other device. In some embodiments, the device 102 may still also be a server computer, desktop computer, laptop computer, netbook computer, tablet or slate computer, wireless handset, cellular telephone, game console or any other type of computing device.

The hardware components 104 may include a processor 108, random access memory 110, and nonvolatile storage 112. The hardware components 104 may also include a user interface 114 and network interface 116. The processor 108 may be made up of several processors or processor cores in some embodiments. The random access memory 110 may be memory that may be readily accessible to and addressable by the processor 108. The nonvolatile storage 112 may be storage that persists after the device 102 is shut down. The nonvolatile storage 112 may be any type of storage device, including hard disk, solid state memory devices, magnetic tape, optical storage, or other type of storage. The nonvolatile storage 112 may be read only or read/write capable.

The user interface 114 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 116 may be any type of connection to another computer. In many embodiments, the network interface 116 may be a wired Ethernet connection. Other embodiments may include wired or wireless connections over various communication protocols.

The software components 106 may include an operating system 118 on which various applications and services may operate. An operating system may provide an abstraction layer between executing routines and the hardware components 104, and may include various routines and functions that communicate directly with various hardware components.

Embodiment 100 illustrates an embodiment where a user's device 102 may perform the role of location analyzer. Other embodiments may have a location analyzer function performed by a remote server, which may be located in a local area network, in a wide area network such as the Internet, or as a cloud based analysis tool accessed over a network connection.

The device 102 may contain a location analyzer 120 which may analyze a calendar database 122 and various calendar items 124 to determine locations for calendar items. The calendar items 124 may be appointments, reminders, or any other database item that contains a date and time designation. In many cases, a calendar item may contain parameters such as a location designation, subject description, attendees, reminder flags, time zone indicators, recurrence information, categorization identifiers, importance designators, notes, time zone designators, privacy identifiers, attachments, hyperlinks, or any other information or identifier. In many cases, calendar items may have additional metadata, including owner, created by, created time, forwarded by, sent to, or other information.

A user may normally access the calendar items 124 using a calendar application. In many embodiments, a calendar database 122 may be shared across multiple devices, such as a desktop computer, a cellular telephone, and a tablet computer, where each device may have a different calendar application to access, update, and edit calendar items 124. In many such embodiments, the calendar database 122 may be located in a cloud based service and accessed over a network.

The calendar database 122 may contain calendar items 124 that may give a glimpse into a user's normal activities. In some embodiments, a user may identify a normal user routine 126 that may include various aspects of a user's schedule. Some embodiments may automatically identify a normal user routine 126 by analyzing a user's calendar items or other information that indicates date, time, and location.

The normal user routine 126 may be a default schedule or set of locations that a location analyzer 120 may use to identify a location for a particular calendar item. During an analysis of a given calendar item, if that item falls within the normal user routine 126, the locations defined in the normal user routine 126 may be given a high probability of a match.

A geo-location receiver 128 may be a hardware or software system that defines where the device 102 is located at any particular time. Different technologies may be able to track the location using different degrees of accuracy. In some cases, the tracked location may be very coarse, such as defining a location within several miles or possibly only within a specific country or state. In other cases, the tracked location may locate the device 102 within a radius of several feet.

The geo-location receiver 128 may create a history log 130 that may contain locations along with a date and time stamp for each location identified. In some embodiments, a location analyzer 120 may attempt to match a user's calendar item with a record in the history log 130 to determine where a past calendar event may have taken place.

In such embodiments, the location of the calendar item may be inferred from the history log 130 when it is assumed that the device 102 may have been carried to the location of the calendar item. If the device 102 were not present at the location of the calendar item, such an assumption may be incorrect and the analysis may be less reliable. Some embodiments may analyze the history log 130 to determine if such an assumption may be valid or not. For example, if the history log 130 indicates that the device 102 were stationary for a long period of time, the device 102 may be assumed to be left at home or in the office and not taken to an appointment on the calendar.

An email application 132 may receive and process email that are stored in an email database 134. The email in the email database 134 may contain a date and time indicator, and may also give hints for locations from where an email may have been sent or received. For example, an email may be sent from a specific Internet Protocol (IP) address and received by a device at a second IP address. Each of the addresses may be resolved into a physical location in some situations using a location resolver service 160. Based on the physical location, date, and time information, a location analyzer 120 may be able to infer when and where a user may have been when an email was sent or received.

A picture database 136 may include pictures stored on the device 102 or accessible by the device 102 over a network connection. In many cases, a picture may have metadata, such as date, time, and location. Based on the metadata, a location analyzer 120 may infer where a user or device 102 may have been physically located when the picture was taken.

A network connection log 138 may be a log file that includes connections, statuses, and other information about the device 102 and its connections to various networks. Entries in the network connection log 138 may include date and timestamps, and some entries may include information that may be resolved into physical locations. For example, establishing a network connection at a coffee shop may create an entry in the network connection log 138 that includes an IP address, which can be resolved into a location.

The location analyzer 120 may analyze any data object in other database 140 that has a date and timestamp and for which a location may be resolved. In some cases, the other databases 140 may include document databases, financial transaction databases, or other data.

A network 142 may connect the device 102 to various other services and servers.

A social network 144 may include many items that have a date and time designator and from which location information may be inferred. The social network 144 may have a social network application 146 through which users may post information that is stored in a social network database 148. The information may include pictures 150, checkins 152, and other information. As described above, pictures with date, time, and location information may be used to infer a location for a user, especially when the user may be tagged or linked to a specific picture.

The social network 144 may provide other clues or data from which a user's location may be inferred. A user's postings may include references to meetings or activities that may be attended by other users. Some social networks allow users to ‘check in’ at various physical locations, which provide date, time, and location for the user.

Financial servers 154 may also provide information about the location of a user at a given date and time. A financial web service 156 may provide access to financial database 158 that may store various transactions. Each transaction may have a date and timestamp, and in many cases, a location may be inferred or expressly defined. For example, credit card transactions, loyalty program transactions, public or private transportation transactions, or any other financial transaction may be analyzed to identify a date, time, and location.

Some embodiments may use a location resolver service 160 and a mapping service 162. The location resolver service 160 may receive various parameters and returning a location. Some embodiments may resolve a location for IP addresses, telephone numbers, zip codes, addresses, Global Positioning System coordinates, or any other data.

In many embodiments, the ‘location’ determined for a calendar item may be a common name of a physical location, which may be a descriptor that may be meaningful to a user. For example, a location of “Main Street Coffee at 123 Main Street” may be a common name whereas the coffee shop's latitude and longitude coordinates may not be meaningful or useful to the user.

In such embodiments, the mapping service 162 and location resolver service 160 may attempt to find a common or meaningful name for a given location designator. For example, when a location designator is an IP address or GPS coordinates, the mapping service 162 or location resolver service 160 may return a business name, person's home, or other location that may be in a text or other description. Other embodiments may use a street address, GPS coordinates, or other location designations.

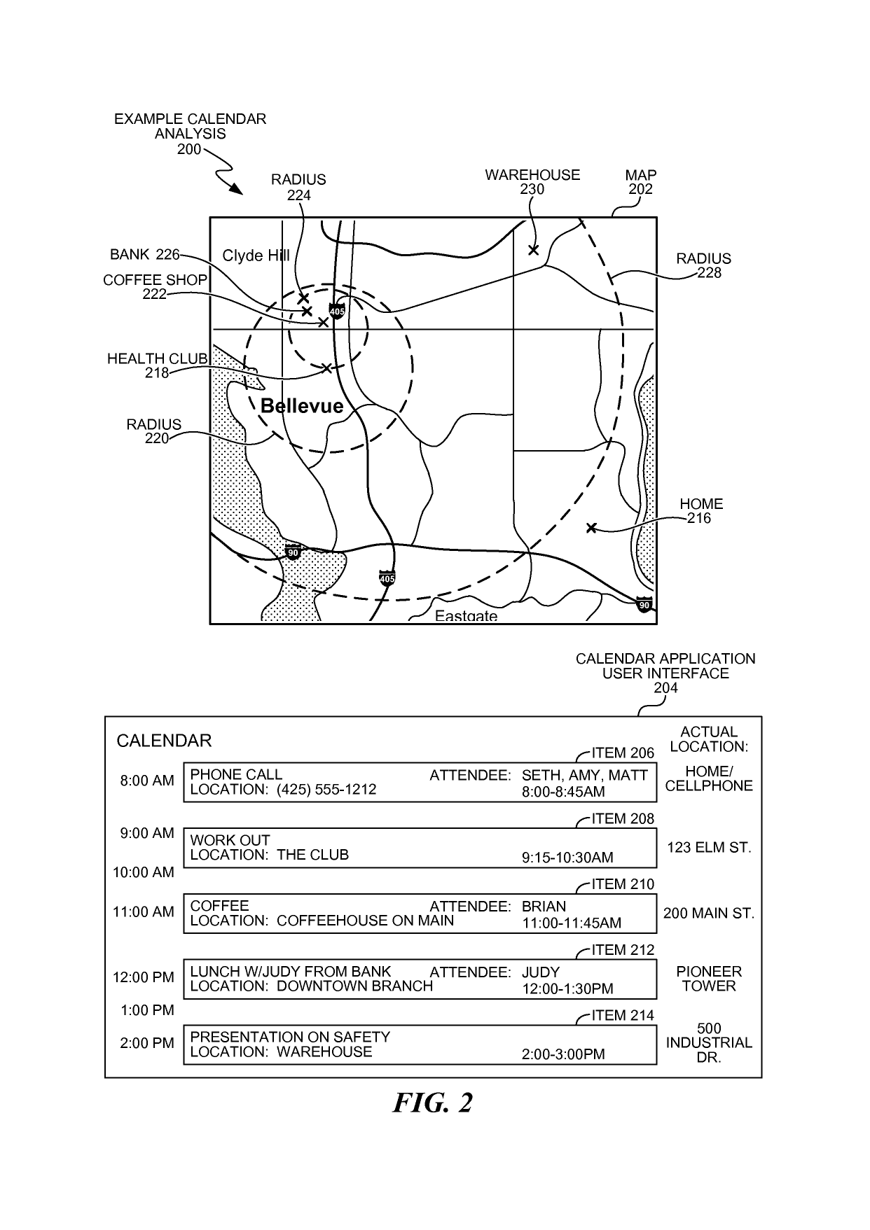

FIG. 2 is a diagram illustration of an example embodiment 200 showing several calendar items and a map showing the physical location of those items. A map 202 shows the locations of various calendar items and a calendar application user interface 204 illustrates several calendar items that may be analyzed.

Embodiment 200 is merely one example of analyses that may be performed on calendar items. The examples are selected to demonstrate the logic that may be used to determine an exact location.

Several calendar items are illustrated for analysis. Item 206 is listed as a phone call where the location is a telephone number. Several attendees are also listed.

An analysis of the item 206 may proceed as follows. The location of a phone number may indicate that the user's location could be unknown, as a user may connect to a conference call from anywhere. However, a user may have a predefined normal user routine which generally indicates that the user often does not leave for work until 9:00 am. Based on the normal user routine, a high probability may be assigned to the location being at the user's home. The user's home 216 is shown on the map.

Item 208 indicates that the user will work out at “the club”. The term “the club” may be the user's shorthand notation for an athletic club to which the user has a subscription. Because the location “the club” is not easily resolvable, an analysis may identify other items that are nearby in time and attempt to determine a travel radius for those items to identify a boundary in which to search. In this instance, the user may have a health monitoring system that may record the user's workout. As part of the monitoring system, a monitoring device may incorporate a GPS receiver or the monitoring system may plug into a computer system at the health club to download the user's workout. Based on the transaction with the health monitoring system, a location analyzer may determine with high probability that the user was at the health club 218 at 123 Elm Street.

Item 210 may indicate a location of “coffee house on Main”. The description of “coffee house on Main” may have some hints as to the location, but may not be definitive. A location analyzer may begin the analysis by determining a distance that the user may have travelled from another location. In the case of item 210, the location analyzer may have a high confidence in the location of item 208. Based on a mode of transportation of driving and the amount of time between the end of item 208 and the beginning of item 210, a radius 220 may be calculated using the health club 218 as a starting point.

The radius 220 may be an approximation of the distance that the user may be capable of travelling given a known or probable location, an amount of time to travel, and a mode of transportation. The radius 220 indicates an approximate boundary in which a more detailed search may be performed to find an actual location. In some embodiments, several items may be analyzed to determine possible boundaries, and the intersection of multiple boundaries may define a search area for a second step of analysis.

In many embodiments, a mode of transportation may be assumed from a user's default normal routine or from some other preference setting. Some embodiments may assume a mode of transportation using information from a user's travel itinerary. For example, a user's travel itinerary for a business trip may include a rental car. Based on the rental car entry, the user may be assumed to have a car. When the user's travel itinerary includes shuttle services from an airport to a hotel, for example, the user's mode of travel may be either walking or a taxi.

When two or more different modes of transportation are possible, a location analyzer may apply different probabilities to each mode of transportation. The probabilities may be used to rank or select various possible locations.

Once the radius 220 has been established, a search may be performed within the boundary. In many embodiments, matches within the boundary may be given a higher probability than matches that may be located outside the boundary.

Within the boundary, a search may be performed to find locations that have a relationship to the calendar item in some fashion. The search may involve searching historical calendar items to find similar items that were located within or near the boundary. In some instances, the search may attempt to identify a location within the boundary based on the information contained in a calendar item. In the example of item 210, a search may identify the possible coffee shops within the boundary of radius 220. From the set of coffee shops, the term “main” may be searched to identify a handful of coffee shops that have some reference to the term “main”. A further search may identify a previous credit card transaction at a coffee shop 222 at 200 Main Street.

In the example, a search may be performed within the boundary, then items having relationships to possible matches may be evaluated. Based on the relationships established between the items, a probability may be assigned to each possible match. A most likely candidate may be selected based on the probabilities.

In some embodiments, a user may be asked to select between possible matches. In such embodiments, when two or more matches are found to be similar in probabilities, or when no item has a probability that is higher than a predefined threshold, a user interface may be presented where a user may select between two, three, or more options as possible locations. The user may also have an option to manually enter a location that may not have been automatically identified.

Item 212 indicates a lunch appointment with Judy. The location is listed as “downtown branch”. The location analyzer may attempt to identify Judy from the user's contact list. Judy may be the user's banker and may work at the downtown branch of a bank. The location analyzer may select this particular Judy from the user's contact list because Judy's work location is within a walking radius 224 of the coffee shop 222 for the user's previous appointment.

In this example, the boundary of where a user may be able to travel from the appointment at the coffee shop to the appointment at lunch is rather small. Within this boundary, the search system may find Judy's contact information, as Judy's work address may be within the boundary. The relationship between Judy's contact information and the calendar item 212 is very strong, since Judy's name is listed as an attendee. Thus, Judy's office address 226 is the likely meeting place for calendar item 212.

Item 214 indicates a presentation that is performed at “warehouse”. Again, the term “warehouse” may be the user's shorthand notation to remind the user where to go, but the term “warehouse” may be difficult to precisely locate. A location analyzer may identify a radius 228 that indicates a boundary where the user could drive, given the time difference between appointments. Within the boundary, a search system may attempt to find items that relate to the calendar item.

Continuing with the example, a search system may find the user's company name and various addresses associated with the company. One of the addresses may be a distribution center located within the radius 228. The relationship of the user's employer and the similarities of the “warehouse” and the company's distribution center may lead to a high probability that the calendar item 214 occurred at the warehouse 230 on the map 202.

The examples illustrated in embodiment 200 are not intended to be comprehensive, but are chosen to illustrate different ways a location analyzer may determine the probability of a calendar item being at a specific location.

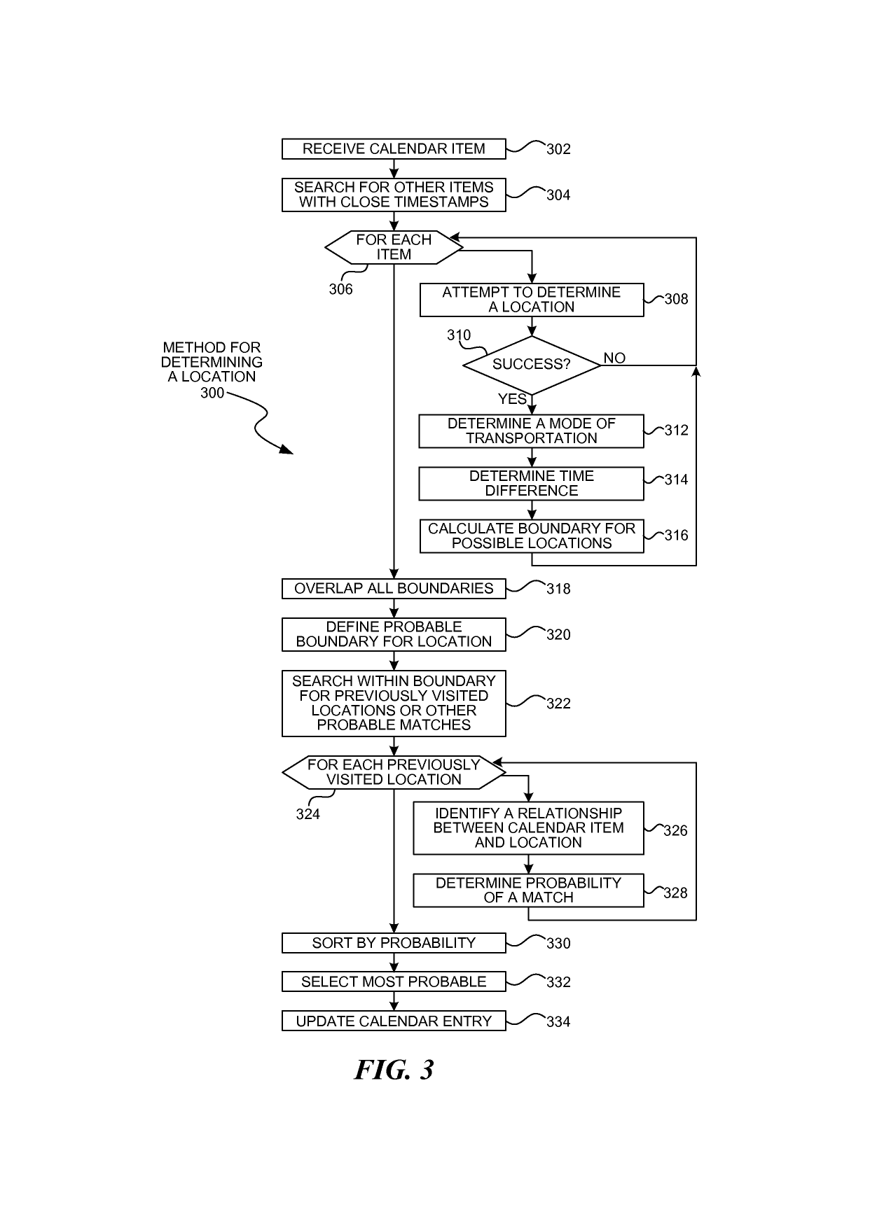

FIG. 3 is a flowchart illustration of an embodiment 300 showing a method for determining a location for calendar items. The process of embodiment 300 is a simplified example of one method through which a location may be determined by identifying a boundary, then searching within the boundary.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 illustrates a two-step method for determining a location for a calendar item. The first step may define a boundary for the location, which may assume that the location is likely to be within the boundary. The second step may be to search for items that may have some relationship to locations within the boundary. Based on the relationships from the search results and the calendar item, a probability may be assigned to each result. An item with the highest probability may be selected and used as the location.

In block 302, a calendar item may be received.

A search may be performed in block 304 to identify other items that have close timestamps. The items may be other calendar items, financial transactions, social network items, or any other item that may have a date and timestamp as well as an implicit or explicit location.

Each item may be processed in block 306. For each item in block 306, an attempt to determine a location may be made in block 308. If a location cannot be determined for the item in block 310, the sequence may return to block 306 to process another item.

If the location is determined in block 310, a mode of transportation may be determined in block 312, as well as the time difference between the calendar item and the item being analyzed. A boundary may be determined in block 314 to identify the possible locations that the calendar item may be. The process may return to block 306.

Once all of the possible boundaries are determined, the boundaries may be overlapped in block 318 to define a probable boundary for the location in block 320. In many cases, the probable boundary may be the intersections of all of the boundaries defined in block 316.

A search may be performed for items that may be located within the boundary. The items may come from many different sources, including other calendar items, financial transactions, social network postings, and other items. The items identified in block 322 may be any item that has a location and a relationship to the calendar item of block 302. The items identified in block 322 may or may not have a time and date similarity or relationship to the calendar item. In some cases, the items of block 322 may be locations that were previously visited by the user.

The items identified in block 322 may be analyzed in block 324. For each of the items, a relationship between the calendar item and the location may be identified in block 326. Based on the relationship, a probability of a match may be identified in block 328.

After analyzing all of the possible locations in block 324, the list of locations may be sorted by probability in block 330 and the most probable location may be selected in block 332. After selecting the most probable location, the calendar entry may be updated in block 334.

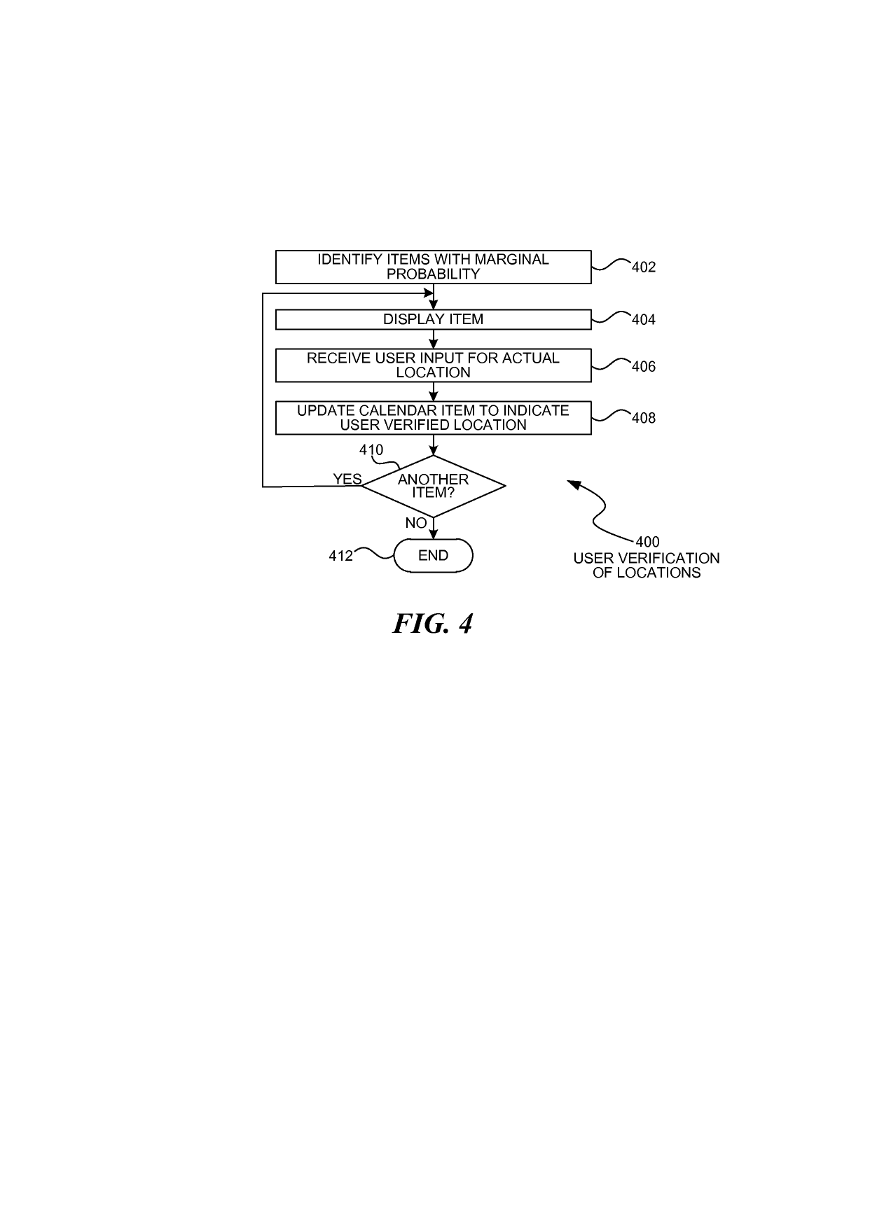

FIG. 4 is a flowchart illustration of an embodiment 400 showing a method for manually identifying locations for calendar items. The process of embodiment 400 is a simplified example of one method by which user input may be captured to identify location information.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 illustrates one sequence whereby location information for calendar items may be manually classified. Embodiment 400 may be used after a location analysis has been performed. Items that have marginal or questionable locations may be presented to a user, and the user may manually determine the actual location associated with a calendar item.

In block 402, items with marginal location probability may be identified. Each embodiment may define which items have marginal probability in different manners. One method may be to identify items that are close to a threshold used to select a location based on their probability value.

The items may be displayed in block 404.

The user may view the automatically suggested location and may enter a manual value regarding the location in block 406. In some cases, the user may verify that an automatically generated location was correct. The calendar item may be updated in block 408.

If more calendar items exist in block 410, the process may return to block 404. Once all the calendar items are analyzed in block 410, the process may end in block 412.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method performed by computer processor, said method comprising:
receiving a first calendar item, said calendar item being an electronic data object having a plurality of parameters, said parameters comprising a date and time designation;
determining a location for said first calendar item by a geo-normalization method comprising:
determining a context for said first calendar item by analyzing a second item and determining a first relationship between said first calendar item and said second item;
determining a first location for said second item;
determining a first location radius for said first calendar item based on said first location and a time difference between said first calendar item and said second item.

2. The method of claim 1, said geo-normalization method further comprising:
determining said first location radius by determining a mode of transportation.

3. The method of claim 2, said mode of transportation being inferred from said first calendar item.

4. The method of claim 2, said mode of transportation being inferred from said second item.

5. The method of claim 3, said mode of transportation being predefined for a locational area.

6. The method of claim 3, said mode of transportation being determined from a travel reservation, said travel reservation having a time period and said second item being within said time period.

7. The method of claim 6, said travel reservation being determined from a second calendar item.

8. The method of claim 1, said geo-normalization method further comprising:
applying a heuristic to said first location to determine a probability for said first location.

9. The method of claim 8, said heuristic comprising at least one rule having a time of day parameter.

10. The method of claim 8, said heuristic comprising at least one rule having a day of week parameter.

11. The method of claim 1, said geo-normalization method further comprising:
said second item being a checkin, said checkin comprising a date and time designation and a third location designation.

12. The method of claim 11, said second item being derived from a device having a Global Positioning System receiver.

13. The method of claim 12, said device further comprising a camera, said second item being a photograph comprising Global Positioning System metadata.

14. The method of claim 11, said geo-normalization method further comprising:
analyzing a transaction history comprising transactions having a date and time designation and further having location designations to identify said second item, said second item comprising one of said transactions;

15. The method of claim 11, said geo-normalization method further comprising:
identifying an attendee for said first calendar item;
determining a third location for said attendee at a third time;
determining a second location radius for said first calendar item based on said third location and a time difference between said first calendar item and said third location.

16. The method of claim 1, said geo-normalizing method further comprising:
identifying said location by identifying a probable location within said first location radius;
determining a relationship between said first calendar item and said probable location;
determining a probability for said probable location based on said relationship; and
selecting said probable location as said location based on said probability.
